(19) United States
(12) Patent Application Publication
(10) Pub. No.: US 2026/0332093 A1
(43) Pub. Date: Oct. 22, 2026

(54) FUSED FAULT DIAGNOSIS METHOD FOR DISTRIBUTED PHOTOVOLTAIC SYSTEM, AND RELATED DEVICE

(71) Applicant: Huaneng Jiangxi Clean Energy Generation Co., Ltd, Nanchang (CN)

(72) Inventors: Yu ZHANG, Nanchang (CN); Xuwei YI, Nanchang (CN); Fulong CHEN, Nanchang (CN); Wei XIONG, Nanchang (CN); Tinglin LIU, Nanchang (CN)

(73) Assignee: Huaneng Jiangxi Clean Energy Generation Co., Ltd, Nanchang (CN)

(21) Appl. No.: 19/287,774

(22) Filed: Jul. 31, 2025

Related U.S. Application Data
(63) Continuation of application No. PCT/CN2025/101029, filed on Jun. 13, 2025.

(30) Foreign Application Priority Data
Apr. 17, 2025 (CN) 2025104847496

(51) Int. Cl. H02S 50/15; G06T 3/4046; G06T 7/00; G06T 7/11

(52) U.S. Cl. CPC H02S 50/15; G06T 3/4046; G06T 7/0002; G06T 7/11; G06T 2207/10048; G06T 2207/20076; G06T 2207/20081; G06T 2207/20084; G06T 2207/20132

(57) ABSTRACT

Disclosed are a fused fault diagnosis method for a distributed photovoltaic system, and a related device. The method includes: collecting and pre-processing sensor time-series data and an infrared image of a photovoltaic system; extracting an original time-series feature and a frequency-domain feature from sensor time-series data, splicing the original time-series feature and the frequency-domain feature into a time-series feature vector, inputting the time-series feature vector into a support vector machine (SVM) model, obtaining a second probability vector, inputting a infrared image into a convolutional neural network (CNN) model, and obtaining a first probability vector; performing weighted fusion on the first probability vector and the second probability vector, and obtaining a weighted score vector; and calculating confidence of the weighted score vector, obtaining a fault category according to the weighted score vector and completing fused fault diagnosis in a case that the confidence calculated satisfies a preset confidence condition.

### CROSS-REFERENCE TO RELATED APPLICATIONS

The application claims priority to Chinese patent application No. 2025104847496, filed on Apr. 17, 2025, the entire contents of which are incorporated herein by reference.

### TECHNICAL FIELD

The present disclosure belongs to the technical field of fault diagnosis, and particularly relates to a fused fault diagnosis method for a distributed photovoltaic system, and a related device.

### BACKGROUND

A distributed photovoltaic system, a crucial infrastructure in the field of renewable energy, is faced with complex and changeable environmental conditions in practical application, such as fluctuations in light intensity, drastic changes in temperature, and differences in humidity. Due to these factors, multiple faults are likely to be caused in photovoltaic modules, inverters, brackets, etc. Common fault types include component voltage imbalance, inverter grid-connected failure, photovoltaic (PV) array overvoltage, insulation performance degradation, excessive leakage currents, power grid parameter abnormality, hardware aging, etc. These faults directly affect power generation efficiency of the system, and probably cause potential safety hazards and economic losses.

For fault diagnosis of the photovoltaic system, it is common practice to rely on a single sensor data source or a simple multi-source data fused diagnosis method in the prior art. A fixed weight assignment mechanism is generally used in a conventional fused diagnosis method. To be specific, the same weight is assigned to all types of sensor data under different working conditions. Such a static weight strategy ignores the influence of dynamic environment changes on sensor performance. Thus, fluctuational diagnosis accuracy and insufficient robustness are caused because the fixed weight assignment mechanism hardly adapts to diagnosis requirements under complex working conditions. In addition, due to the lack of effective confidence evaluation and feedback mechanisms, the majority of existing methods often directly output diagnosis conclusions rather than quantitatively evaluate the confidence of the conclusions. When noise interference, data conflict, or model uncertainty exists in sensor data, mistaken determination or missed determination will be likely to be caused by the lack of confidence evaluation, and thus overall performance of a diagnosis system will be reduced.

### SUMMARY

An objective of the present disclosure is to provide a fused fault diagnosis method for a distributed photovoltaic system, and a related device. Thus, mistaken determination or missed determination caused by a fixed weight assignment mechanism and the lack of effective confidence evaluation and feedback mechanisms during fault diagnosis in the prior art is solved.

In order to realize the above objective, the present disclosure employs the technical solution as follows:

In a first aspect, a fused fault diagnosis method for a distributed photovoltaic system is provided. The method includes:
collecting and pre-processing sensor time-series data and an infrared image of a photovoltaic system;
extracting an original time-series feature and a frequency-domain feature from pre-processed sensor time-series data, splicing the original time-series feature and the frequency-domain feature into a time-series feature vector, inputting the time-series feature vector into a pre-trained support vector machine (SVM) model, obtaining a second probability vector, inputting a pre-processed infrared image into a pre-trained convolutional neural network (CNN) model, and obtaining a first probability vector;
performing weighted fusion on the first probability vector and the second probability vector based on a fusion weight, and obtaining a weighted score vector, where the fusion weight is adjusted and obtained according to a Bayes formula based on confidence data of latest N times of fault diagnosis for the CNN model and the SVM model; and
calculating confidence of the weighted score vector based on a preset score threshold, obtaining a fault category according to the weighted score vector and completing fused fault diagnosis in a case that the confidence calculated satisfies a preset confidence condition, and otherwise collecting and pre-processing the sensor time-series data and the infrared image of the photovoltaic system anew.

In some embodiments, the collecting and pre-processing sensor time-series data and an infrared image of a photovoltaic system specifically include:
collecting the sensor time-series data and the infrared image of the photovoltaic system;
eliminating an abnormal value from the sensor time-series data, performing normalization, and obtaining the pre-processed sensor time-series data; and
zooming the infrared image, cropping a zoomed infrared image to a uniform size, performing random rotation and brightness adjustment, and obtaining the pre-processed infrared image.

In some embodiments, a backbone network of the pre-trained CNN model is of a residual network-18 (ResNet-18) architecture, a number of neurons in a last fully connected layer is equal to a number of fault categories, and each fully connected layer is connected with a dropout layer.

In some embodiments, a pre-training process of the SVM model includes:
acquiring a time-series data set, extracting the original time-series feature and the frequency-domain feature from the sensor time-series data in the time-series data set, splicing the original time-series feature and the frequency-domain feature into the time-series feature vector, obtaining a time-series feature vector data set, and dividing the time-series feature vector data set into a training set, a verification set, and a test set;
optimizing a hyperparameter of the SVM model through the training set and the verification set;
initializing the SVM model through an optimized hyperparameter, and then training the SVM model through the training set and the verification set; calculating, after every M times of fault diagnosis are performed, accuracy of the SVM model anew through M/2 times of diagnosis results during pre-training, and adjusting a category weight of the SVM model; and extracting the original time-series feature and the frequency-domain feature anew, optimizing the hyperparameter anew, and training the SVM model anew when the accuracy is continuously lower than a preset accuracy threshold several times, until a maximum training number is reached.

In some embodiments, the performing weighted fusion on the first probability vector and the second probability vector based on a fusion weight, and obtaining a weighted score vector specifically include:
recording confidence data of the latest N times of fault diagnosis for the CNN model and the SVM model separately through a sliding window;
adjusting the fusion weight according to the Bayes formula based on the confidence data of the latest N times of fault diagnosis for the CNN model and the SVM model, and obtaining an updated dynamic fusion weight; and
performing the weighted fusion on the first probability vector and the second probability vector based on the updated dynamic fusion weight, and obtaining the weighted score vector.

In some embodiments, the calculating confidence of the weighted score vector, obtaining a fault category according to the weighted score vector and completing fused fault diagnosis in a case that the confidence calculated satisfies a preset confidence condition, and otherwise collecting and pre-processing the sensor time-series data and the infrared image of the photovoltaic system anew specifically include:
calculating the confidence according to the weighted score vector and the preset score threshold, where the confidence is a difference between a highest diagnosis score of the weighted score vector and the preset score threshold;
outputting a fault category corresponding to the highest diagnosis score of the weighted score vector and completing the fused fault diagnosis when the confidence is greater than or equal to 0; and
collecting and pre-processing the sensor time-series data and the infrared image of the photovoltaic system anew and performing subsequent steps anew when the confidence is less than 0.

In a second aspect, a fused fault diagnosis system for a distributed photovoltaic system is provided. The system includes:
a data collection module configured to collect and pre-process sensor time-series data and an infrared image of a photovoltaic system;
a dual-model fault diagnosis module configured to extract an original time-series feature and a frequency-domain feature from pre-processed sensor time-series data, splice the original time-series feature and the frequency-domain feature into a time-series feature vector, input the time-series feature vector to a pre-trained SVM model, obtain a second probability vector, input a pre-processed infrared image into a pre-trained CNN model, and obtain a first probability vector;
a result fusion module configured to perform weighted fusion on the first probability vector and the second probability vector based on a fusion weight, and obtain a weighted score vector, where the fusion weight is adjusted and obtained according to a Bayes formula based on confidence data of latest N times of fault diagnosis for the CNN model and the SVM model; and
a confidence determination module configured to calculate confidence of the weighted score vector based on a preset score threshold, obtain a fault category according to the weighted score vector and complete fused fault diagnosis in a case that the confidence calculated satisfies a preset confidence condition.

In a third aspect, an electronic device is provided. The electronic device includes a memory, a processor, and a computer program stored in the memory and runnable in the processor, where the processor, when executing the computer program, implements steps of the fused fault diagnosis method for a distributed photovoltaic system.

In a fourth aspect, a computer-readable storage medium is provided. The computer-readable storage medium stores a computer program, where the computer program, when executed by a processor, implements steps of the fused fault diagnosis method for a distributed photovoltaic system.

In a fifth aspect, a computer program product is provided. The computer program product includes a computer program, where the computer program, when executed by a processor, implements steps of the fused fault diagnosis method for a distributed photovoltaic system.

Compared with the prior art, the present disclosure has the beneficial effects as follows:

According to the present disclosure, the fused fault diagnosis is performed on the distributed photovoltaic system through two heterogeneous data sources including the sensor time-series data and the infrared image. The sensor time-series data reflect a time-series feature of a system running state, and the infrared image captures temperature distribution, etc. of an apparatus. The image and the sensor time-series data are processed by the CNN model and the SVM model respectively, and finally the weighted fusion is performed. Thus, multi-granularity and multi-modal fault features can be extracted, information limitation of a single data source can be effectively compensated, and comprehensiveness and accuracy of diagnosis can be improved. Moreover, according to the present disclosure, the fusion weight of the CNN model and the SVM model is adjusted according to the Bayes formula based on the confidence data of the latest N times of fault diagnosis for the CNN model and the SVM model, and the updated dynamic fusion weight is obtained. Based on the updated dynamic fusion weight, the weighted fusion is performed on the first probability vector and the second probability vector, and the weighted score vector is obtained. Thus, compared with a conventional fused diagnosis method employing a fixed weight assignment mechanism, according to the present disclosure, the fusion weight of the CNN model and the SVM model can be dynamically adjusted according to real-time working conditions and environmental conditions. Thus, multi-source information can be optimally fused under different environments, and flexibility and environmental adaptability of the diagnosis are significantly improved. In addition, according to the present disclosure, the confidence of the weighted score vector is calculated, a diagnosis result is output only when the confidence satisfies the preset confidence condition, and otherwise the sensor time-series data and the infrared image of the photovoltaic system are collected and pre-processed anew, and the subsequent flow of fault diagnosis is triggered. Through the confidence evaluation and feedback mechanisms, reliability of the diagnosis result is effectively quantified, mistaken determination and missed determination caused by low-quality data or model uncertainty are avoided, and accuracy of the fault diagnosis is significantly improved.

Further, according to the present disclosure, the CNN model employs a residual network-18 (ResNet-18) backbone network, a residual connection structure of which effectively alleviates gradient disappearance and supports deeper feature extraction. A dropout layer is added after each fully connected layer. Thus, some neurons are randomly discarded, so as to prevent overfitting of the model, and improve generalization performance and stability of the model.

Further, in the pre-training process of the SVM model, the performance of the model is periodically evaluated through recent diagnosis results. Thus, the category weight is dynamically adjusted. Moreover, when the accuracy is continuously lower than the accuracy threshold, the original time-series feature and the frequency-domain feature are extracted anew, the hyperparameter is optimized anew, and the SVM model is trained anew. Such a self-update mechanism ensures that the model can adapt to changes in data distribution and maintain high diagnostic accuracy for a long time.

### BRIEF DESCRIPTION OF DRAWINGS

FIG. 1 is a flowchart of a fused fault diagnosis method for a distributed photovoltaic system according to an example; and

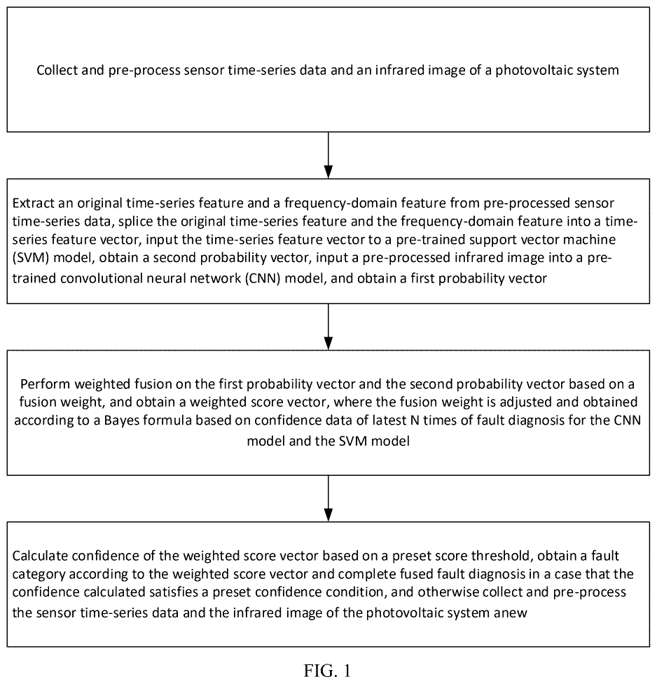

FIG. 2 is a structural diagram of a fused fault diagnosis system for a distributed photovoltaic system according to an example.

### DETAILED DESCRIPTION OF THE EMBODIMENTS

In order to enable those skilled in the art to better understand the solution of the present disclosure, the technical solution of the present disclosure will be further described in detail below in conjunction with the accompanying drawings. The contents are to explain the present disclosure, instead of limiting the present disclosure.

It should be noted that in the description and claims of the present disclosure, the terms “comprise”, “include”, “have”, and their any variants are intended to cover the non-exclusive inclusion. For example, a process, method, system, product, or apparatus that includes a series of steps or units is not necessarily limited to those steps or units expressly listed, but can include other steps or units not expressly listed or inherent to such a process, method, system, product, or apparatus.

A fused fault diagnosis method for a distributed photovoltaic system is provided in the example. The method includes:

### S1, Data Collection and Pre-Processing

Sensor time-series data and an infrared image, monitored in real time, of a photovoltaic system are collected. An abnormal value generated due to sensor noise or communication interruption is eliminated from the sensor time-series data. Then, the sensor time-series data are processed through Z-score normalization, Min-Max zooming is performed on a pixel value of the infrared image to [0, 1], and a zoomed infrared image is cropped to a uniform size.

A zoomed and cropped infrared image undergoes random rotation and brightness adjustment, so as to enhance data. A Gaussian noise is added to normalized sensor time-series data. Finally, a time-series data set and an infrared image data set are obtained.

The sensor time-series data indicate serialized data continuously collected from a sensor at a fixed or variable time interval and ranked. According to the present disclosure, high-accuracy sensors may be mounted at a photovoltaic module, an inverter, a combiner box, etc. so as to collect the sensor time-series data such as a voltage, a current, power, a temperature, irradiance, etc. The infrared image, for example, an infrared image of the photovoltaic module, may be acquired by a thermal infrared imager carried on an unmanned aerial vehicle.

According to the present disclosure, the sensor time-series data undergo abnormal value elimination, normalization, and Gaussian noise addition, real data distribution is simulated, and robustness of the model to the noise is enhanced. The infrared image undergoes zooming, cropping, random rotation, and brightness adjustment. Thus, data diversity is expanded, and generalization capability of the model is improved.

### S2, Dual-Model Training and Verification

### S2.1, Convolutional Neural Network (CNN) Model Construction

A backbone network of the CNN model employs a ResNet-18 architecture, a last fully connected layer is replaced by a fully connected layer having a number of neurons equal to a number of fault categories, an original convolutional layer structure is retained, an image feature is extracted, and a dropout layer is added after the fully connected layer, so that overfitting is prevented.

The infrared image data set enhanced in the stage S1 is divided into a training set, a verification set, and a test set, and a fault category label is converted into a one-hot vector, so as to be stored in a pair with the infrared image.

Firstly, a training parameter is initialized, an initial learning rate is set, a decay period is defined, and an early stopping patience period is set. The training set is input into the CNN model for training, a hyperparameter of the CNN model is optimized through the verification set, and a current optimal verification set loss and an optimal verification set accuracy are recorded.

The above operation is started from the first epoch until a preset maximum epoch number is reached or an early stopping condition is triggered.

If the current verification set accuracy is higher than a historical optimal verification set accuracy, the current CNN model is saved, and a previously-saved optimal CNN model is deleted. Thus, it is ensured that a CNN model having optimal performance is retained all the time.

If the preset maximum epoch number is reached and no early stopping is triggered, training of all epochs is completed. If an early stopping condition is triggered, training is terminated in advance. After training is ended, a pre-trained optimal CNN model is obtained.

Generalization performance of the pre-trained optimal CNN model is verified through the test set.

### S2.2, Support Vector Machine (SVM) Model Construction

An original time-series feature and a frequency-domain feature are extracted from the sensor time-series data in the time-series data set in S1, the original time-series feature and the frequency-domain feature are spliced into a time-series feature vector, and a time-series feature vector data set is obtained. The original time-series feature indicates a mean value and a variance that are calculated according to the sensor time-series data, and the frequency-domain feature is extracted through Fourier transform. The time-series feature vector data set is divided into a training set, a verification set, and a test set.

A hyperparameter is optimized as follows: a hyperparameter of the SVM model is optimized through the training set and the verification set. The hyperparameter (including a radial basis function (RBF) kernel parameter and a regularization parameter) of the SVM model is selected through grid search, and verified through five-fold cross verification. A parameter combination having a highest average verification set accuracy is selected as an optimal hyperparameter.

The SVM model is initialized through an optimized hyperparameter, and a multi-classification problem is processed according to a one-versus-one (OvO) strategy. A category weight is set according to a proportion of various samples in the training set, so that category imbalance is alleviated.

The SVM model is trained through the training set and the verification set. In a training process, after every M times (for example, 100 times) of diagnosis are performed by the SVM model, accuracy of the SVM model is calculated anew through the latest M/2 times of diagnosis results, and the category weight is adjusted. If the accuracy of the trained SVM model is continuously lower than a preset accuracy threshold several times (for example, 3 times) when the category weight is updated, the original time-series feature and the frequency-domain feature are extracted and spliced anew, the time-series feature vector data set is divided anew, the hyperparameter is optimized anew, and the SVM model is initiated and trained anew, until a maximum training number is reached. After training is ended, a pre-trained SVM model is obtained.

Generalization performance of the pre-trained SVM model is verified through the test set.

### S3, Real-Time Fused Diagnosis

Fault data (including the infrared image and the sensor time-series data) collected in real time are acquired and pre-processed as follows: an abnormal value generated due to sensor noise or communication interruption is eliminated from the sensor time-series data. Then, the sensor time-series data are processed through Z-score normalization, and pre-processed sensor time-series data are obtained. Min-Max zooming is performed on a pixel value of the infrared image to [0, 1], a zoomed infrared image is cropped to a uniform size, and a pre-processed infrared image is obtained. An original time-series feature and a frequency-domain feature are extracted from the pre-processed sensor time-series data, and spliced into a time-series feature vector.

The pre-processed infrared image is input into the pre-trained CNN model, and a first probability vector is output. The time-series feature vector is input into the pre-trained SVM model, and a second probability vector is output.

Accuracy and F1-score key indexes of the CNN model and the SVM model on respective verification sets are analyzed, and initial fusion weight assignment is performed.

A fixed update period is specifically set based on a number of times of diagnosis. Confidence of the latest N times of fault diagnosis for the CNN model and the SVM model is recorded separately through a sliding window. After each diagnose, confidence data in the sliding window are updated. A fusion weight is adjusted according to the Bayes formula based on the confidence data, and an updated dynamic fusion weight is updated.

Finally, the weighted fusion is performed on the first probability vector and the second probability vector based on the updated dynamic fusion weight, and a weighted score vector is obtained.

### S4, Confidence Verification and Optimization

Confidence is calculated according to the weighted score vector and a preset score threshold, where the confidence is a difference between a highest diagnosis score of the weighted score vector and the preset score threshold. If the confidence is greater than or equal to 0, a current diagnosis result is accepted, and a fault category corresponding to the highest diagnosis score of the weighted score vector is output. If the confidence is less than 0, a current diagnosis result is not accepted, and the sensor time-series data and the infrared image of the photovoltaic system are collected anew for fused fault diagnosis.

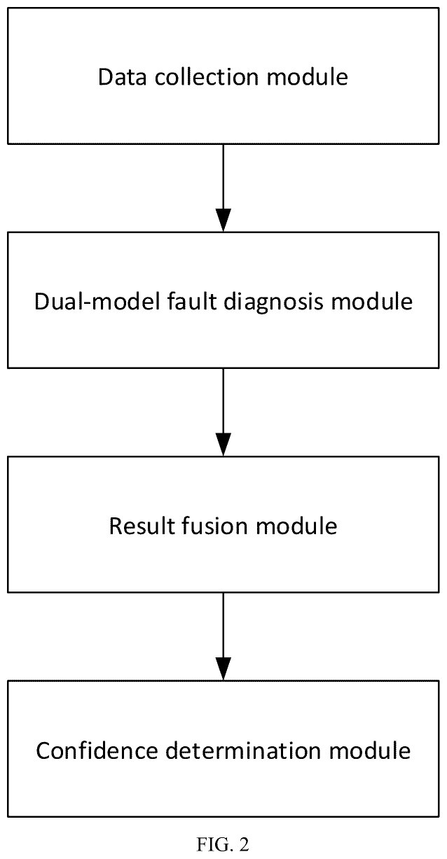

As shown in FIG. 2, a fused fault diagnosis system for a distributed photovoltaic system is further provided in the example. The system includes:
a data collection module configured to collect and pre-process sensor time-series data and an infrared image of a photovoltaic system;
a dual-model fault diagnosis module configured to extract an original time-series feature and a frequency-domain feature from pre-processed sensor time-series data, splice the original time-series feature and the frequency-domain feature into a time-series feature vector, input the time-series feature vector to a pre-trained SVM model, obtain a second probability vector, input a pre-processed infrared image into a pre-trained CNN model, and obtain a first probability vector;
a result fusion module configured to perform weighted fusion on the first probability vector and the second probability vector based on a fusion weight, and obtain a weighted score vector, where the fusion weight is adjusted and obtained according to a Bayes formula based on confidence data of latest N times of fault diagnosis for the CNN model and the SVM model; and
a confidence determination module configured to calculate confidence of the weighted score vector based on a preset score threshold, obtain a fault category according to the weighted score vector and complete fused fault diagnosis in a case that the confidence calculated satisfies a preset confidence condition.

In the examples of the present disclosure, the module division is illustrative. The modules are divided merely by logical function. Other division methods can be employed during practical implementation. Also, in each example of the present disclosure, each function module can be integrated in one processor or physically-present individually. Two or more modules can alternatively be integrated into one module. The above integrated module can be implemented in a form of hardware or a software function module.

A computer apparatus is further provided in the example. The computer apparatus includes a processor and a memory, where the memory is configured to store a computer program (in the example, the computer program includes a calculation component and an iteration component that can perform model calculation and model update respectively), the computer program includes program instructions, and the processor is configured to execute the program instructions stored in the computer storage medium. The processor is probably a central processing unit (CPU), another general-purpose processor, digital signal processor (DSP), application specific integrated circuit (ASIC), field-programmable gate array (FPGA), or another programmable logic device, discrete gate or transistor logic device, discrete hardware component, etc. The processor is a calculation core and a control core of a terminal, is adapted to implement one or more instructions, and is specifically adapted to load and execute one or more instructions in the computer storage medium, so as to implement corresponding method flows or corresponding functions. The processor according to the example of the present disclosure may be configured for the operation of the fused fault diagnosis method for a distributed photovoltaic system.

A storage medium is further provided in the example. The storage medium is specifically a computer-readable storage medium. The computer-readable storage medium, a memory apparatus in a computer apparatus, is configured to store a program and data. It can be understood that the computer-readable storage medium herein may include a built-in storage medium in the computer apparatus, and of course, may also include an extended storage medium supported by the computer apparatus. The computer-readable storage medium provides storage space that stores an operating system of the terminal. Moreover, one or more instructions adapted to be loaded and executed by the processor are further stored in the storage space, and these instructions may be one or more computer programs (including program codes). It should be noted that the computer-readable storage medium herein may be a high-speed random access memory (RAM) or a non-volatile memory, such as at least one magnetic disk memory. One or more instructions stored in the computer-readable storage medium may be loaded and executed by the processor, so as to implement corresponding steps of the fused fault diagnosis method for a distributed photovoltaic system in the above example.

A computer program product is further provided in the example. The computer program product includes a computer program, where the computer program, when executed by a processor, implements corresponding steps of the fused fault diagnosis method for a distributed photovoltaic system in the above example.

Those skilled in the art should understand that the example of the present disclosure can be provided as a method, a system, or a computer program product. Thus, the present disclosure can be in a form of full hardware examples, full software examples, or software and hardware combined examples. Moreover, the present disclosure can be in a form of a computer program product implemented on one or more computer-usable storage media (including, but not limited to, a disk memory, a compact disc read-only memory (CD-ROM), an optical memory, etc.) that encompass computer-usable program codes.

The present disclosure is described with reference to flowcharts and/or block diagrams of the method, apparatus (system), and the computer program product according to the example of the present disclosure. It should be understood that each flow and/or block in the flowcharts and/or the block diagrams, and combinations of the flow and/or the block in the flowcharts and/or the block diagrams can be implemented by the computer program instructions. These computer program instructions can be provided for a processor of a general-purpose computer, a special-purpose computer, an embedded processing machine, or another programmable data processing apparatus, so as to produce one machine. Thus, the instructions executed by the processor of the computer or another programmable data processing apparatus produce a device configured to implement the functions specified in one or more flows in the flowcharts and/or one or more blocks in the block diagrams.

These computer program instructions can alternatively be stored in the computer-readable memory that can guide the computer or another programmable data processing apparatus to work in a specific way. Thus, the instructions stored in the computer-readable memory produce a product including an instruction device. The instruction device implements the functions specified in one or more flows in the flowcharts and/or one or more blocks in the block diagrams.

These computer program instructions can alternatively be loaded on the computer or another programmable data processing apparatus. Thus, a series of operation steps are executed on the computer or another programmable apparatus, so as to generate computer-implementable processing. The instructions executed on the computer or another programmable apparatus provide steps configured to implement the functions specified in one or more flows in the flowcharts and/or one or more blocks in the block diagrams.

Finally, it should be noted that the above examples are merely used to describe the technical solution of the present disclosure, instead of limiting the present disclosure. Although the present disclosure is described in detail with reference to the above examples, those of ordinary skill in the art should understand that they still can make modifications or equivalent substitutions to the particular embodiment of the present disclosure. Any modifications or equivalent substitutions without departing from the spirit and scope of the present disclosure should fall within the scope of protection of the claims of the present disclosure.

What is claimed is:

1. A fused fault diagnosis method for a distributed photovoltaic system, comprising:
collecting and pre-processing sensor time-series data and an infrared image of a photovoltaic system;
extracting an original time-series feature and a frequency-domain feature from pre-processed sensor time-series data, splicing the original time-series feature and the frequency-domain feature into a time-series feature vector, inputting the time-series feature vector into a pre-trained support vector machine (SVM) model, obtaining a second probability vector, inputting a pre-processed infrared image into a pre-trained convolutional neural network (CNN) model, and obtaining a first probability vector;
performing weighted fusion on the first probability vector and the second probability vector based on a fusion weight, and obtaining a weighted score vector, wherein the fusion weight is adjusted and obtained according to a Bayes formula based on confidence data of latest N times of fault diagnosis for the CNN model and the SVM model; and
calculating confidence of the weighted score vector based on a preset score threshold, obtaining a fault category according to the weighted score vector and completing fused fault diagnosis in a case that the confidence calculated satisfies a preset confidence condition, and otherwise collecting and pre-processing the sensor time-series data and the infrared image of the photovoltaic system anew.

2. The fused fault diagnosis method for a distributed photovoltaic system according to claim 1, wherein the collecting and pre-processing sensor time-series data and an infrared image of a photovoltaic system specifically comprise:
collecting the sensor time-series data and the infrared image of the photovoltaic system;
eliminating an abnormal value from the sensor time-series data, performing normalization, and obtaining the pre-processed sensor time-series data; and
zooming the infrared image, cropping a zoomed infrared image to a uniform size, and obtaining the pre-processed infrared image.

3. The fused fault diagnosis method for a distributed photovoltaic system according to claim 1, wherein a backbone network of the pre-trained CNN model is of a residual network-18 (ResNet-18) architecture, a number of neurons in a last fully connected layer is equal to a number of fault categories, and each fully connected layer is connected with a dropout layer.

4. The fused fault diagnosis method for a distributed photovoltaic system according to claim 1, wherein a pre-training process of the SVM model comprises:
acquiring a time-series data set, extracting the original time-series feature and the frequency-domain feature from the sensor time-series data in the time-series data set, splicing the original time-series feature and the frequency-domain feature into the time-series feature vector, obtaining a time-series feature vector data set, and dividing the time-series feature vector data set into a training set, a verification set, and a test set;
optimizing a hyperparameter of the SVM model through the training set and the verification set;
initializing the SVM model through an optimized hyperparameter, and then training the SVM model through the training set and the verification set; calculating, after every M times of fault diagnosis are performed, accuracy of the SVM model anew through M/2 times of diagnosis results during pre-training, and adjusting a category weight of the SVM model; and extracting the original time-series feature and the frequency-domain feature anew, optimizing the hyperparameter anew, and training the SVM model anew when the accuracy is continuously lower than a preset accuracy threshold several times, until a maximum training number is reached.

5. The fused fault diagnosis method for a distributed photovoltaic system according to claim 1, wherein the performing weighted fusion on the first probability vector and the second probability vector based on a fusion weight, and obtaining a weighted score vector specifically comprise:
recording confidence data of the latest N times of fault diagnosis for the CNN model and the SVM model separately through a sliding window;
adjusting the fusion weight according to the Bayes formula based on the confidence data of the latest N times of fault diagnosis for the CNN model and the SVM model, and obtaining an updated fusion weight; and
performing the weighted fusion on the first probability vector and the second probability vector based on the updated fusion weight, and obtaining the weighted score vector.

6. The fused fault diagnosis method for a distributed photovoltaic system according to claim 1, wherein the calculating confidence of the weighted score vector, obtaining a fault category according to the weighted score vector and completing fused fault diagnosis in a case that the confidence calculated satisfies a preset confidence condition, and otherwise collecting and pre-processing the sensor time-series data and the infrared image of the photovoltaic system anew specifically comprise:
calculating the confidence according to the weighted score vector and the preset score threshold, wherein the confidence is a difference between a highest diagnosis score of the weighted score vector and the preset score threshold;
outputting a fault category corresponding to the highest diagnosis score of the weighted score vector and completing the fused fault diagnosis when the confidence is greater than or equal to 0; and
collecting and pre-processing the sensor time-series data and the infrared image of the photovoltaic system when the confidence is less than 0.

7. A fused fault diagnosis system for a distributed photovoltaic system, comprising:
a data collection module configured to collect and pre-process sensor time-series data and an infrared image of a photovoltaic system;
a dual-model fault diagnosis module configured to extract an original time-series feature and a frequency-domain feature from pre-processed sensor time-series data, splice the original time-series feature and the frequency-domain feature into a time-series feature vector, input the time-series feature vector into a pre-trained SVM model, obtain a second probability vector, input a pre-processed infrared image into a pre-trained CNN model, and obtain a first probability vector;
a result fusion module configured to perform weighted fusion on the first probability vector and the second probability vector based on a fusion weight, and obtain a weighted score vector, wherein the fusion weight is adjusted and obtained according to a Bayes formula based on confidence data of latest N times of fault diagnosis for the CNN model and the SVM model; and
a confidence determination module configured to calculate confidence of the weighted score vector based on a preset score threshold, obtain a fault category according to the weighted score vector and complete fused fault diagnosis in a case that the confidence calculated satisfies a preset confidence condition.

8. An electronic device, comprising a memory, a processor, and a computer program stored in the memory and runnable in the processor, wherein the processor, when executing the computer program, implements steps of the fused fault diagnosis method for a distributed photovoltaic system according to claim 1.
